(19) United States
(12) Patent Application Publication
(10) Pub. No.: US 2013/0054885 A1
(43) Pub. Date: Feb. 28, 2013

(54) MULTIPORT MEMORY ELEMENT AND SEMICONDUCTOR DEVICE AND SYSTEM INCLUDING THE SAME

(71) Applicant: Jae-Young CHOI, Hwaseong-si (KR)

(72) Inventor: Jae-Young CHOI, Hwaseong-si (KR)

(73) Assignee: SAMSUNG ELECTRONICS CO., LTD., Suwon-si (KR)

(21) Appl. No.: 13/590,780

(22) Filed: Aug. 21, 2012

(30) Foreign Application Priority Data
Aug. 23, 2011 (KR) 10-2011-0084135

(51) Int. Cl. G06F 12/00

(52) U.S. Cl. 711/105; 711/149; 711/E12.001

(57) ABSTRACT

Provided is a multiport memory element and a semiconductor device including the same. The multiport memory element includes: a first port; a second port different from the first port; a first memory region accessible by a first processor which is coupled to the first port; a second memory region accessible by a second processor which is coupled to the second port; and a common memory region accessible by both the first processor and the second processor, and including a plurality of banks, wherein while the first processor accesses a first bank among the plurality of banks, the second processor accesses a second bank among the plurality of banks.

This application claims priority from Korean Patent Application No. 10-2011-0084135, filed on Aug. 23, 2011 in the Korean Intellectual Property Office, the disclosure of which is incorporated herein by reference in its entirety.

### BACKGROUND

1. Field

Apparatuses and methods consistent with exemplary embodiments relate to a multiport memory element and a semiconductor device and system including the same.

2. Description of the Related Art

A multiprocessor system that employs a plurality of processors in one system is installed in a portable electronic device (such as a portable multimedia player (PMP), a mobile phone, a smart phone, a global positioning system (GPS) a navigation device, a digital camera, a digital video camera, a personal data assistant (PDA), etc.) in order to make the portable electronic device function or operate faster and more smoothly. To meet user demands for convergence, for example, a mobile phone may have a music, game, camera, settlement, or video operation in addition to a basic telephone operation. Therefore, the mobile phone may employ both a communication processor having a communication modulation/demodulation operation and a media processor having an application operation other than the communication operation.

A semiconductor memory employed in a multiprocessor system to store processing data may vary in terms of operation or function. For example, a semiconductor memory may have a plurality of access ports and simultaneously input and output data through the access ports. A related art multiport semiconductor memory device, such as OneDRAM which is a registered trademark of Samsung Electronics, is a fusion memory chip that can significantly increase data processing speed between a communication processor and a medium processor within a mobile device. Typically, two memories are required for two processors. However, since OneDRAM can route data between a plurality of processors through a single chip, a plurality of memories is not required.

### SUMMARY

Aspects of one or more exemplary embodiments provide a multiport memory element having an increased operation speed and an improved operation efficiency.

Aspects of one or more exemplary embodiments also provide a semiconductor device including the multiport memory element.

Aspects of one or more exemplary embodiments also provide a semiconductor system include the semiconductor device.

However, aspects of one or more exemplary embodiments are not restricted to the one set forth herein. The above and other aspects will become more apparent to one of ordinary skill in the art by referencing the detailed description of exemplary embodiments given below.

According to an aspect of an exemplary embodiment, there is provided a multiport memory element including: a first port; a second port different from the first port; a first memory region accessible by a first processor which is coupled to the first port; a second memory region accessible by a second processor which is coupled to the second port; and a common memory region accessible by both the first processor and the second processor and including a plurality of banks, wherein while the first processor accesses a first bank among the plurality of banks, the second processor accesses a second bank among the plurality of banks

According to an aspect of another exemplary embodiment, there is provided a semiconductor device including: one or more nonvolatile memory elements; a memory controller controlling an operation of the one or more nonvolatile memory elements; and a multiport memory element including a first port, a second port different from the first port, a first memory region accessible by the memory controller which is coupled to the first port, a second memory region accessible by a processor which is coupled to the second port, and a common memory region accessible by both the memory controller and the processor, wherein the common memory region includes a plurality of banks, and while the memory controller accesses a first bank among the plurality of banks, the processor accesses a second bank among the plurality of banks.

According to an aspect of another exemplary embodiment, there is provided a semiconductor system including: one or more nonvolatile memory elements; a memory controller controlling an operation of the one or more nonvolatile memory elements; a processor performing an operation; and a multiport memory element including a first port, a second port different from the first port, a first memory region accessible by the memory controller which is coupled to the first port and storing page map data on the one or more nonvolatile memory elements, a second memory region accessible by the processor which is coupled to the second port and used as a system main memory region, and a common memory region accessible by both the memory controller and the processor, wherein the common memory region includes a plurality of banks, and while the memory controller accesses a first bank among the plurality of banks, the processor accesses a second bank among the plurality of banks.

According to an aspect of another exemplary embodiment, there is provided a multiport memory element including: a first port; a second port different from the first port; and a common memory region which is accessible by both a first processor coupled to the first port and a second processor coupled to the second port, and which includes a plurality of banks, wherein a first bank, among the plurality of banks, is accessible by the first processor simultaneously while a second bank, among the plurality of banks, is accessible by the second processor.

According to an aspect of another exemplary embodiment, there is provided a method of operating a multiport memory element including a common memory region, the method including: coupling a first processor to a first port of the multiport memory element and a second processor to a second port, different from the first port, of the multiport memory element; and accessing, by the first processor, a first bank of the common memory region simultaneously while accessing, by a second processor, a second bank of the common memory region.

### BRIEF DESCRIPTION OF THE DRAWINGS

The above and other aspects and features will become more apparent by describing in detail exemplary embodiments with reference to the attached drawings, in which:

FIG. 1 is a block diagram of a semiconductor system according to an exemplary embodiment;

FIG. 2 is a block diagram of a common memory region shown in FIG. 1;

FIG. 3 is a diagram illustrating an application example of a semiconductor system according to an exemplary embodiment;

FIGS. 4 and 5 illustrate a memory module that implements memory linked architecture (MLA) of FIG. 3;

FIG. 6 is a diagram illustrating another application example of a semiconductor system according to an exemplary embodiment;

FIGS. 7 and 8 illustrate a memory module that implements MLA of FIG. 6; and

FIGS. 9 and 10 illustrate a stack package that implements MLA of FIG. 6.

### DETAILED DESCRIPTION OF EXEMPLARY EMBODIMENTS

Exemplary embodiments will now be described more fully hereinafter with reference to the accompanying drawings. An exemplary embodiment may, however, be embodied in different forms and should not be construed as limited to the exemplary embodiments set forth herein. Rather, these exemplary embodiments are provided so that this disclosure will be thorough and complete, and will filly convey the scope of the inventive concept to those skilled in the art. The same reference numbers indicate the same components throughout the specification. In the attached figures, the thickness of layers and regions is exaggerated for clarity.

The use of the terms “a” and “an” and “the” and similar referents in the context of describing exemplary embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Unless defined otherwise, all technical and scientific terms used herein have the same meaning as commonly understood by one of ordinary skill in the art to which this invention belongs. It is noted that the use of any and all examples, or exemplary terms provided herein is intended merely to better illuminate exemplary embodiments and is not a limitation on the scope of the invention unless otherwise specified. Further, unless defined otherwise, all terms defined in generally used dictionaries may not be overly interpreted.

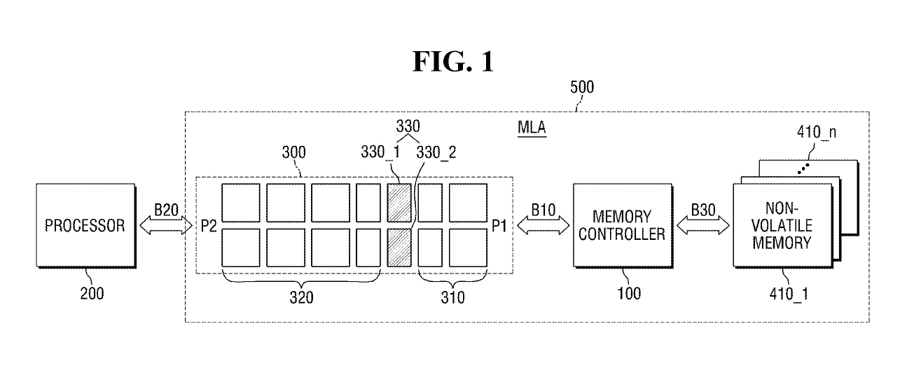

FIG. 1 is a block diagram of a semiconductor system according to an exemplary embodiment.

Referring to FIG. 1, the semiconductor system includes a multiport memory element 300, a memory controller 100, a processor 200, and a plurality of nonvolatile memory elements 410_1 through 410_{—}n.

The memory controller 100 may control an operation of the plurality of nonvolatile memory elements 410_1 through 410_{—}n. Here, the memory controller 100 may include a processor (not shown) (e.g., a first processor) used for its operation. The processor 200 (e.g., a second processor) may serve as a host processor of the semiconductor system. The multiport memory element 300 may be, but is not limited to, OneDRAM.

The memory controller 100, the multiport memory element 300, and the nonvolatile memory elements 410_1 through 410_{—}n form a memory linked architecture (MLA) 500.

Basically, the processor 200 may function and operate as a host processor. Specifically, the processor 200 may perform operations used to drive an operating system (OS) of the semiconductor system.

The memory controller 100 may read data (hereinafter, referred to as ‘raw data’) used for an operation of the processor 200 from the plurality of nonvolatile memory elements 410_1 through 410_{—}n or may write data (hereinafter, referred to as ‘operation data’) resulting from the operation of the processor 200 to the plurality of nonvolatile memory elements 410_1 through 410_{—}n. However, it is understood that another exemplary embodiment is not limited thereto. Additional functions and operations may be added to the memory controller 100 and the processor 200, if necessary or desired.

The memory controller 100 is connected to the multiport memory element 300 via a first data bus B10, and the processor 200 is connected to the multiport memory element 300 via a second data bus B20. That is, the memory controller 100 and the processor 200 share the multiport memory element 300. Therefore, the semiconductor system according to an exemplary embodiment does not need to employ two memory elements for the operation of the memory controller 100 and the processor 200. This ensures low system implementation cost and compact system size.

The plurality of nonvolatile memory elements 410_1 through 410_{—}n are connected to the memory controller 100 via a third data bus B30. Here, bandwidths (e.g., 10.8 GB/s) of the first and second data buses B10 and B20 are greater than a bandwidth (e.g., 3.2 GB/s) of the third data bus B30. Therefore, high-volume raw data read from the plurality of nonvolatile memory elements 410_1 through 410_{—}n can be provided to the processor 200 without a bottleneck, and high-volume operation data provided by the processor 200 can be written to the plurality of nonvolatile memory elements 410_1 through 410_{—}n without a bottleneck. This increases the operation speed of the semiconductor system and improves the operation efficiency of the semiconductor system.

The plurality of nonvolatile memory elements 410_1 through 410_{—}n may be, but are not limited to, flash memory elements. The plurality of nonvolatile memory elements 410 1 through 410_{—}n may have a NOR or NAND structure. Each of the plurality of nonvolatile memory elements 410_1 through 410_{—}n may store data that is not to be erased even when power is turned off, such as the boot code, programs, communication data, or data for preservation of a mobile device.

The multiport memory element 300 operates as a main memory used for the operation of the memory controller 100 and the processor 200. The multiport memory element 300 has first and second ports P1 and P2 and a plurality of memory regions 310 through 330 to allow multiport access.

The first port P1 of the multiport memory element 300 is connected to the memory controller 100 via the first data bus B10, and the second port P2 of the multiport memory element 300 is connected to the processor 200 via the second data bus B20. That is, the memory controller 100 and the processor 200 may access the plurality of memory regions 310 through 330 of the multiport memory element 300 through two different access paths.

The plurality of memory regions 310 through 330 may include a first memory region 310 accessed exclusively by the memory controller 100, a second memory region 320 accessed exclusively by the processor 200, and a common memory region 330 accessed by both the memory controller 100 and the processor 200. The first memory region 310, the second memory region 320, and the common memory region 330 may include dynamic random access memory (DRAM) cells.

In the semiconductor system according to an exemplary embodiment, page map data may be stored in the first memory region 310. The page map data may be used when the memory controller 100 reads raw data from the plurality of nonvolatile memory elements 410_1 through 410_{—}n or writes operation data to the plurality of nonvolatile memory elements 410_1 through 410_{—}n. That is, the memory controller 100 reads raw data from the plurality of nonvolatile memory elements 410_1 through 410_{—}n or writes operation data to the plurality of nonvolatile memory elements 410_1 through 410_{—}n by referring to the page map data stored in the first memory region 310.

The second memory region 320 may be used as a main memory region of the semiconductor system. That is, the second memory region 320 may store data related to operations of the processor 200.

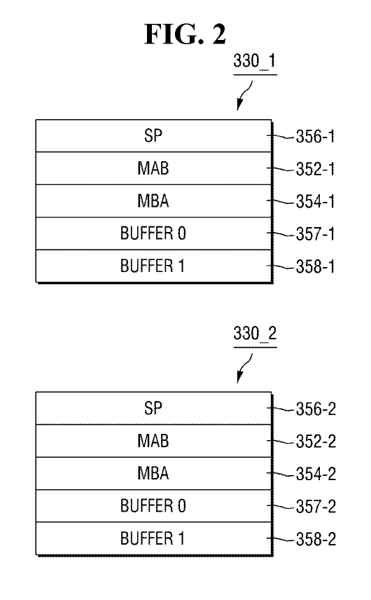

The common memory region 330 may include two or more banks 330_1 and 330_2. In FIG. 1, the common memory region 330 includes two banks 330_1 and 330_2. However, it is understood that another exemplary embodiment is not limited thereto. That is, the common memory region 330 may include three, four, or any number of banks as desired according to one or more other exemplary embodiments. The structure of the common memory region 330 will be described in detail below with reference to FIG. 2.

While the memory controller 100 accesses a first bank (e.g., 330_1) among the banks 330_1 and 330_2, the processor 200 may access a second bank (e.g., 330_2) among the banks 330_1 and 330_2. For example, while the memory controller 100 writes raw data read from the plurality of nonvolatile memory elements 410_1 through 410_{—}n to the first bank 330_1, the processor 200 may read raw data already written by the memory controller 100 from the second bank 330_2.

That is, the memory controller 100 and the processor 200 can simultaneously access the common memory region 330. This can prevent a delay in task execution which may occur when the memory controller 100 waits to access the common memory region 330 while the processor 200 is accessing the common memory region 330. Therefore, the operation speed of the semiconductor system according to an exemplary embodiment may increase.

However, the memory controller 100 and the processor 200 do not simultaneously access one bank (e.g., 330_1). For example, after the memory controller 100 accesses the first bank 330_1, the processor 200 may access the first bank 330_1.

FIG. 2 is a block diagram of the common memory region 330 shown in FIG. 1.

Referring to FIG. 2, the first and second banks 330_1 and 330_2 of the common memory region 330 include semaphores 356_1 and 356_2, first mailboxes 352_1 and 352_2, second mailboxes 354_1 and 354_2, first buffers 357_1 and 357_2, and second buffers 358_1 and 358_2, respectively.

Information about the authority to access the common memory region 330 is stored in the semaphores 356_1 and 356_2. Messages (such as authority requests, addresses, data sizes, transmission data indicating an address of a common memory that stores data, and commands) exchanged between the memory controller 100 and the processor 200 are written to the first mailboxes 352 1 and 352 2 and the second mailboxes 354_1 and 354_2. For example, messages to be transmitted from the memory controller 100 to the processor 200 are written to the first mailboxes 352_1 and 352_2. In addition, messages to be transmitted from the processor 200 to the memory controller 100 are written to the second mailboxes 354_1 and 354_2. By way of example, at least one bit may be allocated to the semaphores 365_1 and 365_2, and four bytes may be allocated to each of the first mailboxes 352_1 and 352_2 and the second mailboxes 354_1 and 354_2.

The first buffers 357_1 and 357_2 and the second buffers 358_1 and 358_2 store data (e.g., raw data or operation data) exchanged between the processor 200 and the memory controller 100.

When a data interface between the memory controller 100 and the processor 200 is implemented through the multiport memory element 300, the memory controller 100 and the processor 200 may write messages, which are to be transmitted to each other, to the first and second mailboxes 352_1 and 352_2 and 354_1 and 354_2, respectively. A receiving end which reads a message written by a transmitting end may perform an operation in response to the message.

Specifically, a case where the memory controller 100 transfers the authority to access the first bank 330_1 of the common memory region 330 to the processor 200 and where the processor 200 transfers the authority to access the second bank 330_2 of the common memory region 330 to the memory controller 100 will be described as an example.

First, the memory controller 100 writes raw data read from the plurality of nonvolatile memory elements 410_1 through 410_{—}n to the first bank 330_1 (e.g., the first buffer 357_1 and the second buffer 358_1). In the present exemplary embodiment, while the memory controller 100 writes the raw data to the first bank 330_1, the processor 200 may read raw data from the second bank 330_2 (e.g., the first buffer 357_2 and the second buffer 358_2). That is, the memory controller 100 may write raw data to the first bank 330_1 at the same time as when the processor 200 reads raw data from the second bank 330_2.

After writing the raw data to the first bank 330_1, the memory controller 100 changes flag data of the semaphore 356_1 and then writes to the first mailbox 352_1 a message notifying the transfer of the authority to access the first bank 330_1. Accordingly, the authority to access the first bank 330_1 is transferred to the processor 200.

After reading the raw data from the second bank 330_2, the processor 200 changes flag data of the semaphore 356_2 and then writes to the second mailbox 354_2 a message notifying the transfer of the authority to access the second bank 330_2. Accordingly, the authority to access the second bank 330_2 is transferred to the memory controller 100.

The processor 200 reads the message notifying the transfer of the authority to access the first bank 330_1 from the first mailbox 352_1 and identifies whether the flag data of the semaphore 356_1 has been changed. Then, the processor 200 writes to the second mailbox 354_2 a response message notifying the reception of the authority to access the first bank 330_1. Thereafter, the processor 200 has the exclusive authority to access the first bank 330_1.

Meanwhile, the memory controller 100 reads the message notifying the transfer of the authority to access the second bank 330_2 from the second mailbox 354_2 and identifies whether the flag data of the semaphore 356_2 has been changed. Then, the memory controller 100 writes to the first mailbox 352_2 a response message notifying the reception of the authority to access the second bank 330_2. Thereafter, the memory controller 100 has the exclusive authority to access the second bank 330_2.

Subsequently, while the memory controller 100 writes raw data to the second bank 330_2, the processor 200 reads raw data from the first bank 330_1. When these read and write operations end, the memory controller 100 and the processor 200 go through the same authority transfer process.

The process of storing operation data, which results from an operation of the processor 200, in the plurality of nonvolatile memory elements 410_1 through 410_{—}n is performed in the reverse order to the above authority transfer process. That is, while the processor 200 writes operation data to the first bank 330_1, the memory controller 100 reads raw data from the second bank 330_2 and writes the read raw data to the plurality of nonvolatile memory elements 410_1 through 410_{—}n by referring to the page map data stored in the first memory region 310.

When these read and write operations end, the processor 200 transfers the authority to access the first bank 330_1 to the memory controller 100, and the memory controller 100 transfers the authority to access the second bank 330_2 to the processor 200. Then, the processor 200 writes operation data to the second bank 330_2, and the memory controller 100 reads raw data from the first bank 330_1 and writes the read raw data to the plurality of nonvolatile memory elements 410_1 through 410_{—}n by referring to the page map data stored in the first memory region 310.

Through the continuous repetition of these read and write operations, raw data stored in the plurality of nonvolatile memory elements 410_1 through 410_{—}n is rapidly delivered to the processor 200 without being constrained by bandwidth, and operation data resulting from an operation of the processor 200 is rapidly stored in the plurality of nonvolatile memory elements 410_1 through 410_{—}n without being constrained by bandwidth.

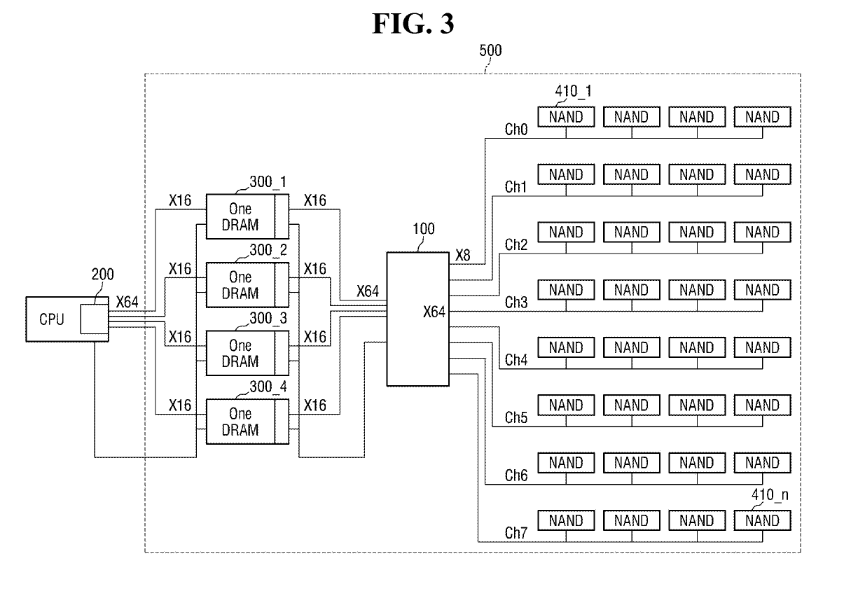

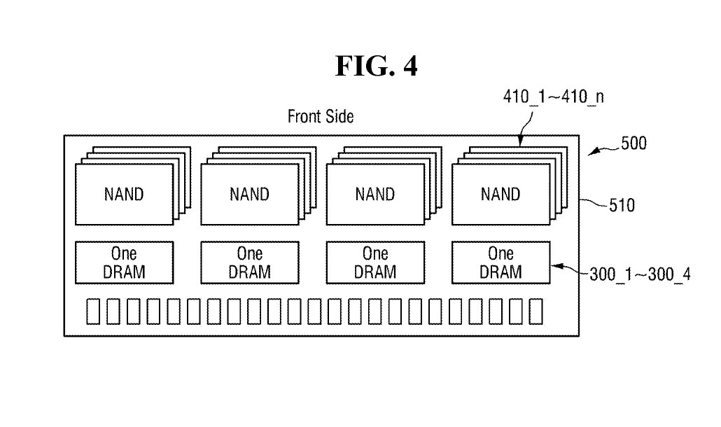

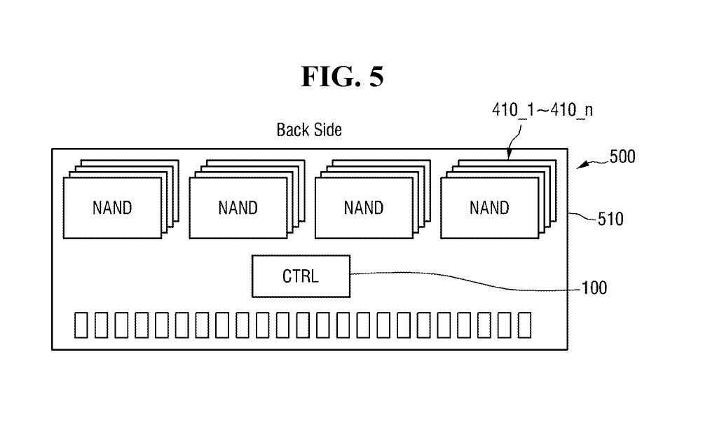

FIG. 3 is a diagram illustrating an application example of a semiconductor system according to an exemplary embodiment. FIGS. 4 and 5 illustrate a memory module that implements the MLA 500 of FIG. 3.

In the application example of FIG. 3, the semiconductor system is applied to a personal computer (PC) (more specifically, a notebook PC), though it is understood that another exemplary embodiment is not limited thereto.

In the present example, an input/output (I/O) of the memory controller 100 may operate at X64, and an I/O of the processor 200 may operate at X64. Therefore, four multiport memory elements 300_1 through 300_4 may be used if their I/O is X16, and two multiport memory elements may be used if their I/O is X32. That is, the number of multiport memory elements used may vary according to the I/O of each multiport memory element.

The memory controller 100 may use eight channels Ch0 through Ch7. In this case, the I/O of each of the channels Ch0 through Ch7 may be X8. Four nonvolatile memory elements 410_1 through 410_{—}n may be connected to each of the channels Ch0 through Ch7. Thus, a total of 32 nonvolatile memory elements 410_1 through 410_{—}n may be used.

A front side of a memory module is illustrated in FIG. 4, and a back side of the memory module is illustrated in FIG. 5.

The multiport memory elements 300_1 through 300_4, the memory controller 100, and the plurality of nonvolatile memory elements 410_1 through 410_{—}n are placed on front and back sides of a circuit board 510 of the memory module.

For example, four multiport memory elements 300_1 through 300_4 and sixteen nonvolatile memory elements 410_1 through 410_{—}n may be placed on the front side of the circuit board 510 of the memory module, and the memory controller 100 and sixteen nonvolatile memory elements 410_1 through 410_{—}n may be placed on the back side of the circuit board 510 of the memory module.

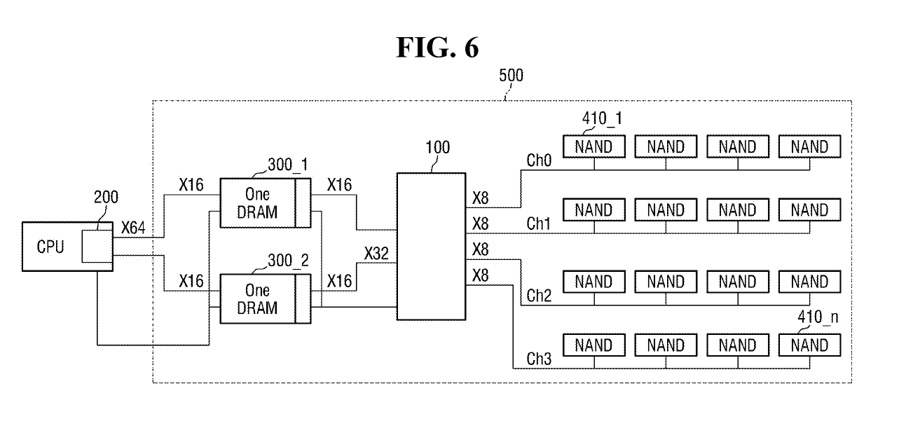

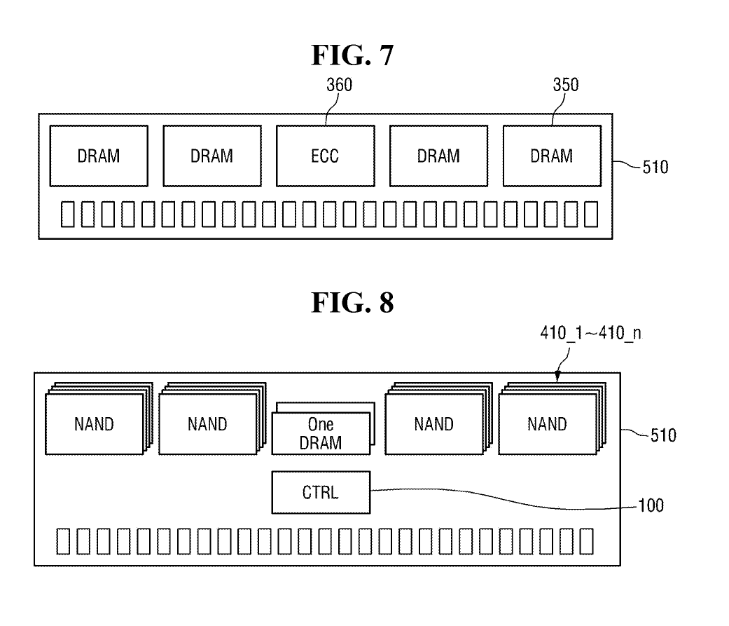

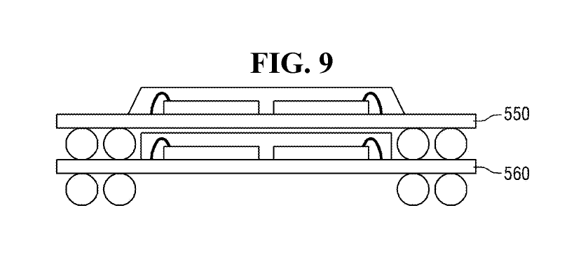

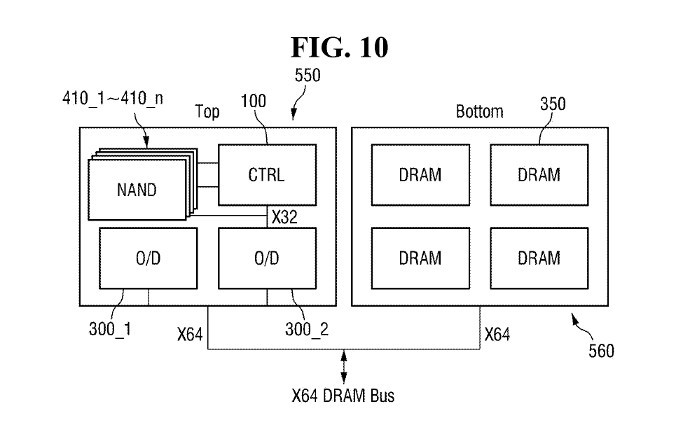

FIG. 6 is a diagram illustrating another application example of a semiconductor system according to an exemplary embodiment. FIGS. 7 and 8 illustrate a memory module that implements the MLA 500 of FIG. 6. FIGS. 9 and 10 illustrate a stack package that implements the MLA 500 of FIG. 6.

In the application example of FIG. 6, the semiconductor system is used in an arm base server, though it is understood that another exemplary embodiment is not limited thereto.

In the present example, the I/O of the memory controller 100 may operate at X32, and the I/O of the processor 200 may operate at X64. Here, a multiport memory element having a first port P1 whose I/O is X16 and a second port P2 whose I/O is X32 may be used. Two such multiport memory elements 300_1 and 300_2 may be used.

The memory controller 100 may use four channels Ch0 through Ch3. In this case, the I/O of each of the channels Ch0 through Ch3 may be X8. Four nonvolatile memory elements 410_1 through 410_{—}n may be connected to each of the channels Ch0 through Ch3. Thus, a total of 16 nonvolatile memory elements 410_1 through 410_{—}n may be used.

A front side of a memory module is illustrated in FIG. 7, and a back side of the memory module is illustrated in FIG. 8.

The multiport memory elements 300_1 and 300_2, the memory controller 100, and a plurality of nonvolatile memory elements 410_1 through 410_{—}n may be placed on a back side of a circuit board 510 of the memory module, and one or more error correcting codes (ECCs) 360 and one or more volatile memory elements 350 may be placed on a front side of the circuit board 510. For example, one ECC 360 and four volatile memory elements 350 may be placed on the front side of the circuit board 510 of the memory module.

Referring to FIGS. 9 and 10, the memory controller 100, two multiport memory elements 300_1 and 300_2, and sixteen nonvolatile memory elements 410_1 through 410_n may be placed on an upper circuit board 550, and four volatile memory elements 350 may be placed on a lower circuit board 560.

In concluding the detailed description, those skilled in the art will appreciate that many variations and modifications can be made to the above-described exemplary embodiments without substantially departing from the principles of the present invention. Therefore, the disclosed exemplary embodiments are used in a generic and descriptive sense only and not for purposes of limitation.

What is claimed is:

1. A multiport memory element comprising:
a first port;
a second port different from the first port;
a first memory region which is accessible by a first processor coupled to the first port;
a second memory region which is accessible by a second processor coupled to the second port; and
a common memory region which is accessible by both the first processor and the second processor and which comprises a plurality of banks,
wherein a first bank, among the plurality of banks, is accessible by the first processor simultaneously while a second bank, among the plurality of banks, is accessible by the second processor.

2. The multiport memory element of claim 1, wherein first data is writeable by the first processor to the first bank, simultaneously while second data is readable by the second processor from the second bank.

3. The multiport memory element of claim 1, wherein each of the plurality of banks comprises a semaphore, a first mailbox, a second mailbox, and a buffer.

4. The multiport memory element of claim 3, wherein the first mailbox stores any messages to be transmitted from the first processor to the second processor, and the second mailbox stores any messages to be transmitted from the second processor to the first processor.

5. The multiport memory element of claim 3, wherein the buffer stores any raw data and any operation data exchanged between the first processor and the second processor.

6. The multiport memory element of claim 1, wherein the first memory region is not accessible by the second processor, and the second memory region is not accessible by the first processor.

7. A semiconductor device comprising:
one or more nonvolatile memory elements;
a memory controller controlling an operation of the one or more nonvolatile memory elements; and
a multiport memory element comprising a first port, a second port different from the first port, a first memory region which is accessible by the memory controller coupled to the first port, a second memory region which is accessible by a processor coupled to the second port, and a common memory region which is accessible by both the memory controller and the processor,
wherein the common memory region comprises a plurality of banks, and
wherein a first bank, among the plurality of banks, is accessible by the memory controller simultaneously while a second bank, among the plurality of banks, is accessible by the processor.

8. The semiconductor device of claim 7, wherein the first memory region stores page map data on the one or more nonvolatile memory elements, and the second memory region is a system main memory of the processor.

9. The semiconductor device of claim 8, wherein while the processor writes data to the second bank, the memory controller reads data from the first bank and writes the read data to the one or more nonvolatile memory elements.

10. The semiconductor device of claim 8, wherein while the processor reads data from the second bank, the memory controller reads data from the one or more nonvolatile memory elements and writes the read data to the first bank.

11. The semiconductor device of claim 7, wherein the one or more nonvolatile memory elements comprise one or more flash memory elements.

12. The semiconductor device of claim 7, further comprising:
a first data bus connecting the memory controller and the multiport memory element;
a second data bus connecting the processor and the multiport memory element; and
a third data bus connecting the one or more nonvolatile memory elements and the memory controller,
wherein a bandwidth of the first data bus and a bandwidth of the second data bus are greater than a bandwidth of the third data bus.

13. The semiconductor device of claim 7, further comprising a circuit board, wherein the multiport memory element is on a first surface of the circuit board, and at least one of the one or more nonvolatile memory elements and the memory controller is on a second surface of the circuit board, different from the first surface.

14. The semiconductor device of claim 7, further comprising a circuit board, wherein a volatile memory element is on a first surface of the circuit board, and at least one of the one or more nonvolatile memory elements, the multiport memory element, and the memory controller is on a second surface of the circuit board, different from the first surface.

15. The semiconductor device of claim 7, further comprising a first circuit board and a second circuit board stacked sequentially, wherein a volatile memory element is on the first circuit board, and at least one of the one or more nonvolatile memory elements, the multiport memory element, and the memory controller is on the second circuit board.

16. The semiconductor device of claim 14, wherein the one or more nonvolatile memory element comprises a dynamic random access memory (DRAM) element.

17. The semiconductor device of claim 7, further comprising the processor which is a host processor for driving an operating system.

18. A multiport memory element comprising:
a first port;
a second port different from the first port; and
a common memory region which is accessible by both a first processor coupled to the first port and a second processor coupled to the second port, and which comprises a plurality of banks,
wherein a first bank, among the plurality of banks, is accessible by the first processor simultaneously while a second bank, among the plurality of banks, is accessible by the second processor.

19. The multiport memory element of claim 18, further comprising a first memory region which is accessible by the first processor and is not accessible by the second processor.

20. The multiport memory element of claim 18, wherein first data is readable by the first processor from the first bank, simultaneously while second data is writeable by the second processor to the second bank.
